(19) United States
(12) Patent Application Publication
(10) Pub. No.: US 2012/0158583 A1
(43) Pub. Date: Jun. 21, 2012

(54) AUTOMATED BANK TRANSFERS USING IDENTIFIER TOKENS

(76) Inventors: HARALD EVERS, Walldorf (DE); Karsten Egetoft, Walldorf (DE); Martin Zurmuehl, Muehlhausen (DE)

(21) Appl. No.: 12/973,901

(22) Filed: Dec. 21, 2010

(51) Int. Cl. G06Q 40/00

(52) U.S. Cl. 705/40

(57) ABSTRACT

Disclosed are methods and systems for automated bank transfer using an identifier token. The methods and systems involve generating an invoice with an identifier token at a payee, the identifier token including bank transfer information of the payee, updating an invoice repository with the invoice and the identifier token and on updating the invoice and the identifier token, generating a notification to the payer, the notification including the identifier token.

### FIELD

The field generally relates to bank transfer and more specifically relates to online bank transfer using an identifier token.

### BACKGROUND

In the modern world, most of the payment processes such as insurance payment, telephone payment, retail payment, utility services related payments, and the like happen through online payments. For an online payment to be made for the above services, the companies associated with the above services may need to generate invoices. On receiving the invoices from the associated companies, the invoice recipient (i.e., a payer) makes a payment through modern banking processes such as mobile banking, online banking and telephone banking or by conventional means in the branch of a bank.

Sometimes, the companies issue invoices to an end customer along with a prefilled bank form for manual payment. As a result, the customer may have to make a payment through manual credit transfer between the customer account and the account of the invoicing company. Manual credit transfer is a tedious process for the customer as the customer may have to enter all the details in the fields of the bank transfer form (e.g., amount, bank sort code, account number, type of account, invoice number or other reference to what is paid) manually.

There may be instances where erroneous data is entered in the bank transfer form. For instance, if the customer makes an error in entering the account number associated with the invoicing company, the amount may get credited to the wrong account. Errors may also occur when bank personnel manually transfer the information from a paper based credit transfer request into internal banking solutions like teller applications. Another example of the impact of erroneous data is when a customer makes an error when entering the invoice reference, in such case the payee is not able to link the payment to the right customer to reconcile the outstanding invoice amount with the customer's account at the payee.

### SUMMARY

Various embodiments of systems and methods for automated bank transfers using an identifier token are described herein. The methods and systems involve generating an invoice with an identifier token at a payee, the identifier token referencing bank transfer information of the payee, updating an invoice repository with the invoice and the identifier token and on updating, generating a notification to the payer, the notification including the identifier token.

On receiving the printed invoice respectively the notification at the computing device of the payer, the payer logging to a bank associated with himself, retrieving payment information associated with the invoice by entering the identifier token at the computing device of the payer, initiating a payment process at the computing device of the payer based on the retrieved payment information, and executing the payment process. In one embodiment, the payer receives a printed invoice as the notification.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an exemplary business scenario for automated bank transfers using an identifier token, according to an embodiment.

FIG. 2 is a flow diagram illustrating an exemplary method for automated bank transfers using an identifier token, according to an embodiment.

FIG. 3 is a flow diagram illustrating an exemplary payment process on a payer side according to an embodiment.

FIG. 4 is a flow diagram illustrating an exemplary method for executing payment according to an embodiment of the invention.

FIG. 5 is a block diagram illustrating a system for automated bank transfers using an identifier token at a payee side according to an embodiment.

FIG. 6 is a block diagram illustrating a system for automated bank transfers using an identifier token at a payer side according to an embodiment.

FIG. 7 is a block diagram of an exemplary computer system according to an embodiment.

### DETAILED DESCRIPTION

Embodiments of techniques for automated bank transfers using identifier tokens are described herein. In the following description, numerous specific details are set forth to provide a thorough understanding of various embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

An invoice is a document issued by a supplier or payee to a customer or payer indicating the invoice number, the product, quantities, and agreed upon prices for products or services that the supplier has provided to the customer. The invoice indicates the payment amount according to the payment terms as agreed between the supplier and the customer and the bank details of the payee identifying the bank account where the payer is asked to pay the outstanding amount of the invoice. The bank details may include information like such as the name of the bank of the payee, the sort code of the bank, the account number and the like. The invoice may include an identifier token. The identifier token refers to the bank transfer information associated with the supplier in an invoice repository. The identifier token may be in the form of a bar code, a radio frequency identifier (RFID) tag, a printed, character-based identifier and the like. The invoice may include customer or payer data such as the name of the customer, the address of the customer, the telephone number of the customer. According to one embodiment, the invoice, along with the identifier token, is loaded on to an invoice repository. A notification is generated to the customer once the invoice and the identifier token are loaded on to the invoice repository. The notification includes the identifier token. According to one embodiment, the customer or payer may use the identifier token to initiate a bank transfer to execute the payment due to the supplier or payee.

According to one embodiment, initiating the payment includes reading the identifier token in the invoice and based on the identifier token retrieving bank transfer information from the invoice repository. The retrieved bank transfer information is used to fill the bank transfer form for making a payment. By filling the bank transfer information in this manner, entering erroneous data in the bank transfer form may be prevented.

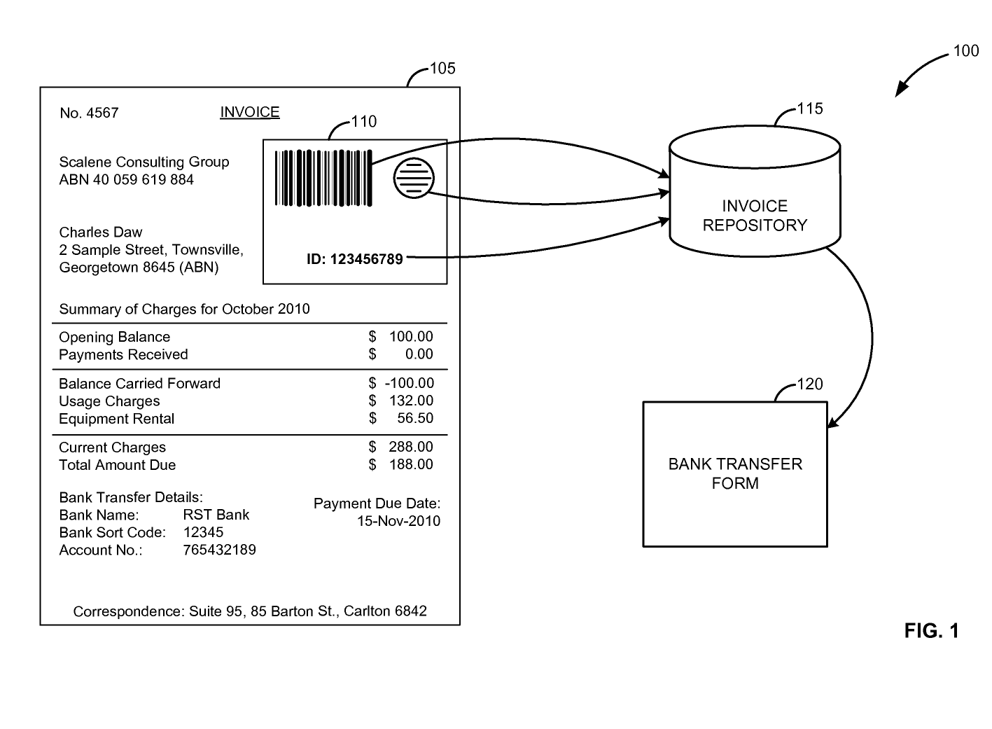

FIG. 1 is a block diagram illustrating an exemplary business scenario for automated bank transfers using an identifier token according to an embodiment. Consider a scenario 100 including an invoice 105. The invoice 105 may include payer data or customer data such as customer ID, customer name, address, items, total amount due, payment due date and so on. The invoice 105 includes an identifier token 110. The identifier token 110 may be but is not restricted to a serial number, a bar code, a radio frequency identifier (RFID) tag, etc. The invoice may also include bank transfer information associated with the payee. The bank transfer information may be a bank account number, a sort code of the bank, a name of the bank and so on associated with the payee. The bank transfer information of the payee is linked to the identifier token 110 of the invoice 105 in an invoice repository 115. In one embodiment, the bank transfer information of the payee is associated with the identifier token in the form of a bar code, serial number, RFID tag and the like. A bank transfer form 120 is automatically updated according to the information linked to the identifier token 110 along with the payer data in the invoice.

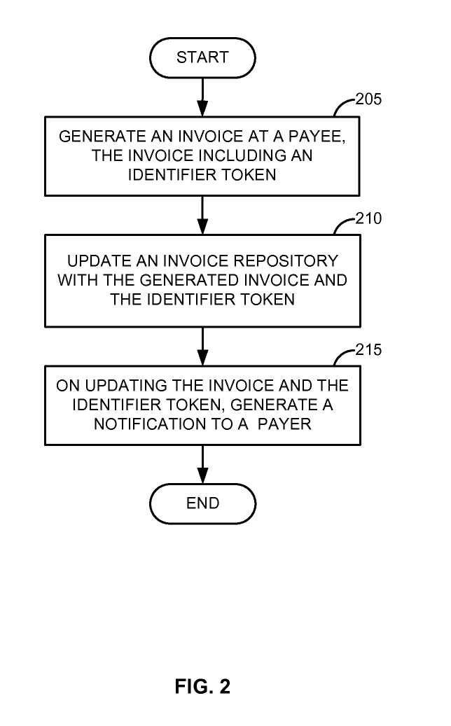

FIG. 2 is a flow diagram illustrating an exemplary method for automated bank transfers using an identifier token according to an embodiment. At process block 205, an invoice with an identifier token is generated at a payee. The invoice includes an identifier token. The invoice includes customer or payer information and bank transfer information of the payee. The invoice may include customer or payer data such as customer ID, customer name, address, items, total amount due, due date and so on. The identifier token is linked to the bank transfer information of the payee in the invoice. The bank transfer information of the payee may be bank account number, sort code of the bank, name of the bank and so on. At process block 210, an invoice repository is updated with the invoice and the identifier token associated with the generated invoice. The invoice repository includes customer or payer data such as customer ID, customer name, telephone number, email ID and so on. In one embodiment, the invoice repository includes an identity management module to map the bank transfer information of the payee and payer data in the invoice repository with the customer or payer data in the invoice. At process block 215, on updating the invoice and the identifier token a notification is generated. In one embodiment, the notification is sent to a computing device of the payer. The computing device may be, but not limited to, mobile devices. The notification includes the identifier token of the invoice. The notification may be a short message service (SMS) or an email notification.

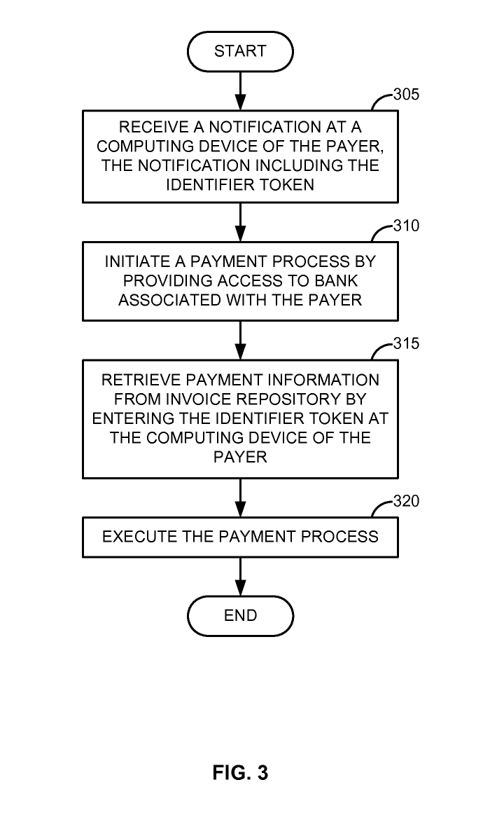

FIG. 3 is a flow diagram illustrating an exemplary payment process on a payer side according to an embodiment. At process block 305, a notification is received at the computing device of the payer. The notification includes the identifier token linked to the bank transfer information associated with the payee. On receiving the notification, the payment process is initiated by providing access to bank associated with the payer at process block 310. In one embodiment, the payer logs into an associated bank by entering an associated customer ID and password. The payer may log into a bank computer system. At process block 315, payment information of the payee is retrieved from the invoice repository by entering the identifier token at the computing device of the payer. The payment information may be the bank transfer information of the payee, payment notes like the invoice number and the payment amount information in the invoice. The payment information of the payee may be retrieved by capturing the identifier token in a printed invoice sent from a payee to the payer. The identifier token may be captured by a scanner or a camera in a mobile device. In one embodiment, the bank of the payer accesses the invoice repository to retrieve the payment information. At process block 320, the payment process is executed.

According to one embodiment, the customer or payer retrieves unprocessed invoices from the invoice repository. The invoices may be retrieved by mapping a bank customer ID of the payer to the customer ID of the payer stored in the invoice repository. The payer may then select an invoice from a list of unprocessed invoices to make a payment.

According to another embodiment of the invention, the payment information retrieved from the invoice repository includes the bank transfer information of the payee which may be automatically filled in a bank transfer form when the user the initiates the payment.

According to another embodiment, initiating the payment process by the payer includes using a printed copy of the invoice sent by the payee and the identifier token in the invoice to make a payment at the bank through teller applications or using RFID tag or barcode scanners. The teller applications or the RFID tag or barcode scanners read the identifier token and retrieve the payment information from the invoice repository and fill the bank transfer form automatically.

According to yet another embodiment, the customer initiates payment through online banking, mobile banking and self service terminals and so on. In such cases, the identifier token is read by a device such as a scanner or a camera of a mobile device.

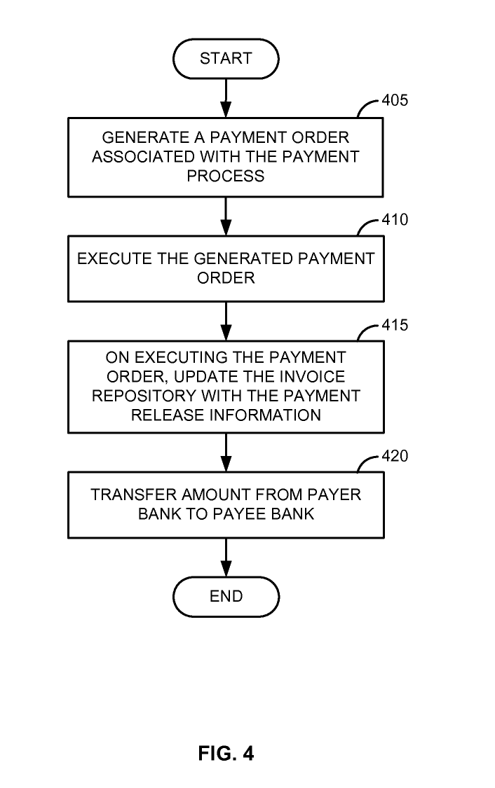

FIG. 4 is a flow diagram illustrating an exemplary method for executing payment according to an embodiment of the invention. At process block 405, an invoice repository generates a payment order associated with the payment process. A payment order includes a request made to the payer bank to release the payment. At process block 410, the generated payment order is executed. Executing the payment order involves releasing the payment from the payer bank. At process block 415, on executing the payment order, the invoice repository is updated with the payment release information. At process block 420, the payer bank transfers the payment amount to the payee bank. In one embodiment, the payee bank generates an electronic bank statement. The electronic bank statement is sent to the payer. The electronic statement is used to reconcile the information from the incoming payment with the item towards which the payment is due in an account receivables application. The invoice repository ensures that the identifier token used by the payer and the payer bank will be included in the electronic bank statement and that the reconciliation within the account receivables application may be fully automated.

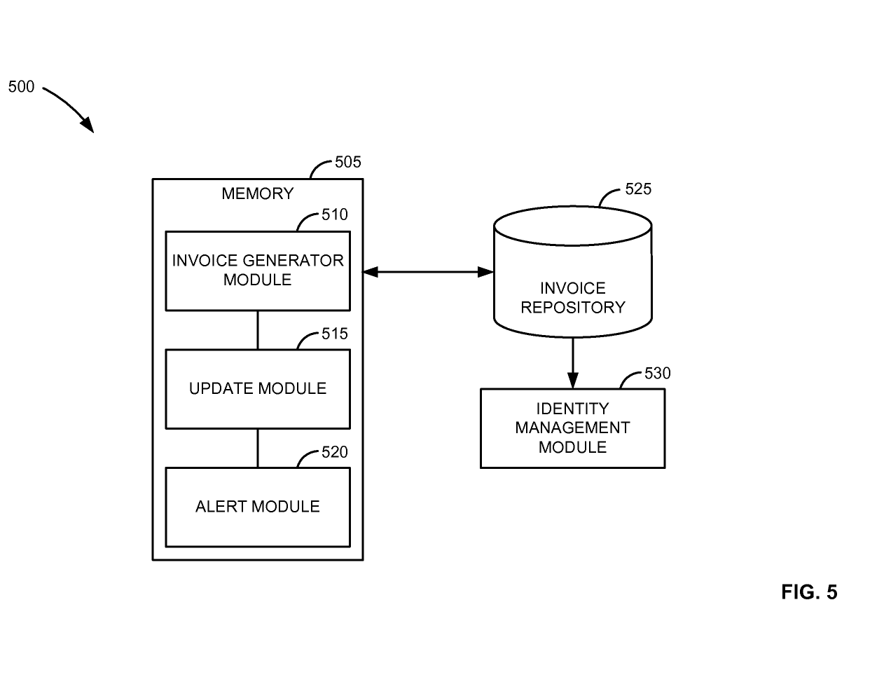

FIG. 5 is a block diagram 500 illustrating a system for automated bank transfers using an identifier token at a payee side according to an embodiment. Consider system 500 with a memory 505 including an invoice generator module 510, an update module 515, and an alert module 520. The invoice generator module 510 generates an invoice with an identifier token. The invoice may include payer data and bank transfer information of the payee. The bank transfer information of the payee is linked to the identifier token. The invoice and the identifier token are updated to an invoice repository 525 by the update module 515. On updating the invoice to the invoice repository 525 the alert module 520 generates a notification to the user. The notification may include the identifier token. Once the invoice is updated to the invoice repository 525, identity management module 530 maps the bank transfer information in the identifier token and the customer or payer data in the invoice to generate the notification to the user.

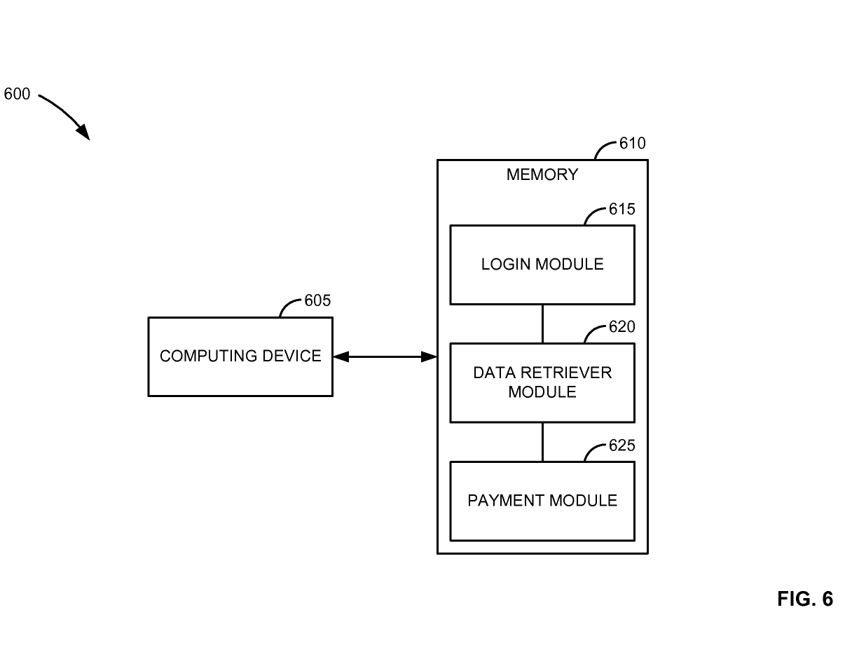

FIG. 6 is a block diagram illustrating a system for automated bank transfers using an identifier token at a payer side according to an embodiment. Consider system 600 with a computing device 605, memory 610 including a login module 615, a data retriever module 620 and a payment module 625. A notification including the identifier token is received at the computing device 605. On receiving the notification, the payer logs in to a payer bank through a login module 615. The payer may need a customer ID and password to login into the payer bank. The data retriever module 620 retrieves data from the invoice repository 525 (as illustrated in FIG. 5). The payer may have to enter the identifier token to retrieve the payment information. According to the type of the identifier token, the identifier token may be captured by a scanner or a camera in a mobile device. The payment module 625 initiates and executes the payment through the computing device 605 of the payer. In one embodiment, the payment execution happens between bank servers of the payer bank and the payee bank. A payment order is generated at the payer bank during the payment execution process. On generating the payment order, a payment may be released by the payer bank to the payee bank. Once the payment is processed at the payee bank an electronic bank statement is generated and forwarded to the payee.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

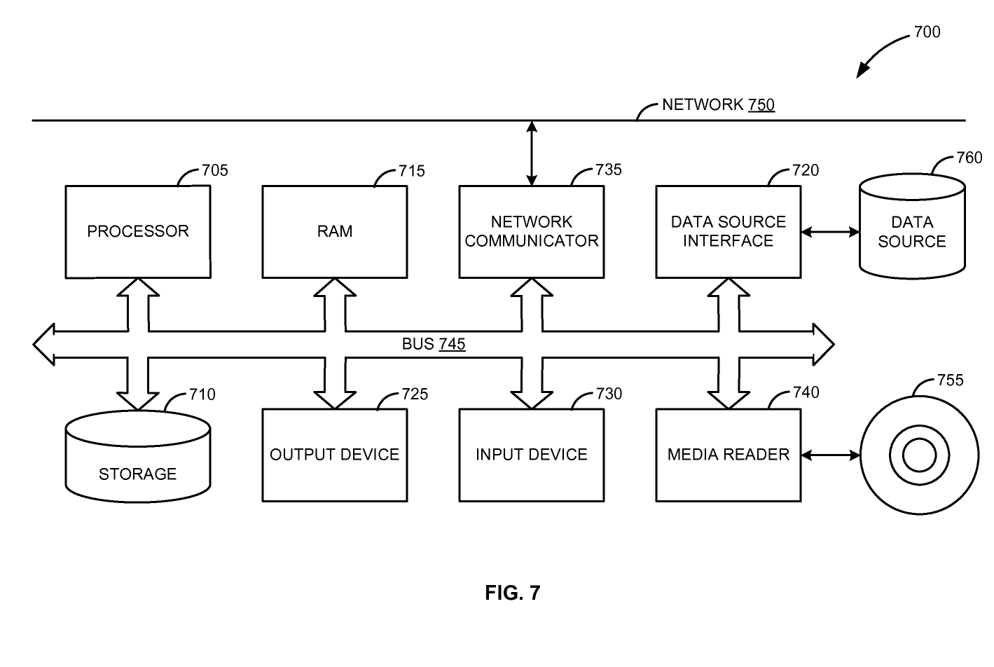

FIG. 7 is a block diagram of an exemplary computer system 700 according to an embodiment. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interacting with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however, that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
generate an invoice with an identifier token at a payee, the identifier token comprising bank transfer information of the payee;
update an invoice repository with the invoice and the identifier token; and
on updating the invoice and the identifier token, generate a notification to a payer, the notification comprising the identifier token.

2. The article of manufacture in claim 1, further comprising instructions to:
receive the notification at a computing device of the payer,
on receiving the notification, initiate a payment process by providing access to bank associated with the payer;
retrieve payment information associated with the invoice by using the identifier token received at the computing device of the payer; and
execute the payment process.

3. The article of manufacture in claim 2, wherein executing the payment process comprises:
generating a payment order associated with the payment process;
executing the generated payment order;
on executing the payment order, updating the invoice repository with the payment release information; and
transferring payment from payer bank to payee bank.

4. The article of manufacture in claim 2, wherein initiating the payment process by providing access to the bank associated with the payer comprises initiating a login session to the bank associated with the payer.

5. The article of manufacture in claim 1, wherein generating the invoice comprises generating the invoice with payer data.

6. The article of manufacture in claim 1, wherein generating the invoice with the identifier token comprises generating the identifier token by linking the bank transfer information of the payee in the invoice.

7. The article of manufacture in claim 1, wherein generating the invoice with the identifier token comprises generating the identifier token in form of a bar code or a RFID tag.

8. The article of manufacture in claim 1, wherein generating the invoice with the identifier token comprises generating the identifier token in form of a serial number.

9. A computer system for automated bank transfers using an identifier token, the computer system comprises:
a processor;
a memory in communication with the processor to include instructions for:
an invoice generator module to generate an invoice with an identifier token, the identifier token comprising bank transfer information of a payee;
an update module to update an invoice repository with the invoice and the identifier token;
an identity management module to map the identifier token with payer data in the invoice repository; and
an alert module to generate a notification to a computing device of the payer;

10. The computer system of claim 9, further comprising:
a login module to login to a bank of the payee;
a data retriever module to retrieve data from the invoice repository based on the identifier token; and
a payment module to initiate payment process based on the retrieved information and to execute the payment process.

11. The computer system of claim 9, wherein the invoice generator generates the identifier token in form of a bar code or a RFID tag.

12. The computer system of claim 9, wherein the invoice generator generates the identifier token in form of a serial number.

13. A computerized method for automated bank transfer using an identifier token, the computerized method comprising:
generating an invoice with an identifier at a payee, the identifier token comprising bank transfer information of the payee;
updating an invoice repository with the invoice and the identifier token; and
on updating the invoice and the identifier token, generating a notification to a payer, the notification comprising the identifier token.

14. The computerized method of claim 13, further comprising:
receiving the notification at a computing device of the payer,
on receiving the notification, initiate a payment process by accessing bank associated with the payer;
retrieving payment information associated with the invoice by using the identifier token received at the computing device of the payer; and
executing the payment process.

15. The computerized method of claim 14, wherein initiating the payment process by providing access to the bank associated with the payer comprises initiating a login session to the bank associated with the payer.

16. The computerized method of claim 14, wherein executing the payment process comprises:
generating a payment order associated with the payment process;
executing the generated payment order;
on executing the payment order, updating the invoice repository with the payment release information; and
transferring payment from payer bank to payee bank.

17. The computerized method of claim 13, wherein generating the invoice comprises generating the invoice with payer data.

18. The computerized method of claim 13, wherein generating the invoice with the identifier token comprises generating the identifier token by linking the bank transfer information of the payee in the invoice.

19. The computerized method of claim 13, wherein generating the invoice with the identifier token comprises generating the identifier token in form of a bar code or a RFID tag.

20. The computerized method of claim 13, wherein generating the invoice with the identifier token comprises generating the identifier token in form of a serial number.
